(19) United States
(12) Patent Application Publication
(10) Pub. No.: US 2003/0014763 A1
(43) Pub. Date: Jan. 16, 2003

(54) Method and apparatus facilitating synchronization in a broadband communications system

(76) Inventors: Christopher L. Chappell, Chandler, AZ (US); Dmitrii A. Loukianov, Chandler, AZ (US); Jeffrey D. Hoffman, Chandler, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/895,789

(22) Filed: Jun. 29, 2001

(51) Int. Cl. H04N 7/173

(52) U.S. Cl. 725/111; 725/105; 725/119

(57) ABSTRACT

A method is presented comprising receiving a data stream comprising timestamp information into a buffer, wherein the received data stream includes gaps, and generating an equalized reference clock from the received data stream by removing the gaps to facilitate equalized processing of the timestamp information received in a non-equalized data stream.

### TECHNICAL FIELD

This invention generally relates to broadband data networks and, more particularly, to a method and apparatus facilitating synchronization in a broadband communication system.

### BACKGROUND

With the increased popularity of the Internet has come an increasing demand for faster Internet access. To meet this demand a number of broadband technologies have been developed such as, for example, Digital Subscriber Line (DSL) and Hybrid Fiber/Coax (HFC) using the cable system data networks provide a broadband access solution that is generally cost effective for even the residential consumer. An example of just such a broadband data network is presented with reference to FIG. 1.

Turning to FIG. 1 an example HFC cable television (CATV) data network is presented. HFC network 100 is depicted comprising a master headend 102, coupled to a number of primary hubs 104A-N via a communication network 106. Each of the primary hubs 104A-N are coupled to secondary hubs 108A-N and, subsequently, a number of fiber nodes 110A-N in a tree-branch configuration as shown. According to one implementation of the HFC network 100, network 106 includes synchronous optical network (SONET) equipment that communicates over single mode fiber (SMF), and the fiber optic communication path extends to the fiber node(s) 110. Each of the fiber nodes 110 provides cable service to network end-points (e.g., residential drops, commercial drops, etc.) via a broadband coaxial connection 112, using repeater amplifiers 114A-N, as needed.

It will be appreciated by those skilled in the art that in order to use any of the broadband systems introduced above, a broadband modem (modulator/demodulator) is required. In accordance with the illustrated cable television example, a cable modem (CM) is required. Cable modems enable a computing system to utilize one or more channels of the broadband signal for the interchange of data with, for example, Internet network elements (e.g., web servers, etc.) through a cable modem termination system (CMTS) typically residing at the head-end of the HFC CATV system. In this regard, cable modems modulate/demodulate data channels in an unused section of the broadcast bandwidth of the cable television (CATV) system.

In accordance with the Data Over Cable Service Interface Specification (DOCSIS 1.1) Radio Frequency Interface Specification SP-RFIv1.1-106-001215 first released Mar. 11, 1999 by the CableLabs® consortium, conventional fiber nodes 110A-N typically broadcast (i.e., the forward or downlink component of the communication channel) to network end-points using M-ary quadrature amplitude modulation (QAM) (e.g., 64- or 256 QAM) in 6 MHz channels over a band from 91-857 MHz.

The upstream (i.e., the reverse or uplink communication channel component) is a time division multiple access (TDMA) modulation scheme, wherein a cable modem 122 transmits in bursts to the fiber node 110A-N using Reed-Solomon encoding and quadrature phase shift-keying (QPSK) or QAM-16 in one of the following channel widths (−30 dB bandwidth) of 200-kHz, 400-kHz, 800-kHz, 1.6-MHz, and 3.2-MHz from 5 to 42-MHz (5-65-MHz for EuroDOCSIS). All cable modems (CM) using a particular upstream channel must request bandwidth from the CMTS. The CMTS controls the upstream channel by selectively granting access to CM's requests for bandwidth.

In order to ensure timing synchronization between the CMTS and the CM's is maintained, the CMTS sends periodic timestamps in the downstream communication packet(s) to all CM's on the node. The timestamps are used by the CM's to control and adjust their local timebases and limit error between the CMTS slot timing and the local CM slot timing.

The forward error correction (FEC) frame packet format used for a 64-QAM downstream is depicted in FIG. 2. In accordance with the detail of FIG. 2, the FEC frame 200 is comprised of 60 Reed-Solomon blocks having 122 symbols and 6 parity symbols. Accordingly, an MPEG framer (e.g., in the CMTS) must convert the FEC symbols, which are up to seven (7) bits, to MPEG bytes (i.e., 8 bits) suitable for transmission in the downstream to CMs in the MPEG data stream. In addition to the 7-bit to 8-bit MPEG conversion, the Reed-Solomon (RS) parity symbols found in the FEC packets must be filtered from the MPEG data stream. Conventionally, RS parity symbol filtering is accomplished by suppressing the 7-bit to 8-bit conversion during the MPEG processing of the RS parity symbols. While this approach accomplishes the task of FEC-to-MPEG data stream formatting, it introduces “gaps” into the resultant MPEG data stream. The gaps generated in this formatting then cause problems with timing synchronization messages that are encapsulated within the MPEG data stream.

Upstream slot timing synchronization is accomplished through the exchange of timing reference messages transferred from the CMTS to the CMs via a media access control (MAC) management message (e.g., type=SYNC) in the downstream. As illustrated in FIG. 2, the SYNC message consists of the value of a 32-bit counter running at 10.24 MHz, and each CM in the system must (re)synchronize to this reference. A typical method implemented in CM's to synchronize to this CMTS reference clock is to utilize a numerically controlled oscillator (NCO) that locks to the value of the timestamps transmitted by the CMTS. Such NCO's require that the jitter between successive timestamps must be controlled to less than 500 ns (0.5 μs) in order to maintain accurate upstream slot timing. Unfortunately, the gaps introduced in the FEC/MPEG framing process described above cause processing variation in the CM between timestamps. Since the frame is asynchronous to MPEG data stream, and thus asynchronous to the timestamp period, there will often be a different total number of gaps in the MPEG data stream between timestamps. This difference causes jitter in the timestamps presented to the NCO and, thus, impairs timebase synchronization.

### BRIEF DESCRIPTION OF THE DRAWINGS

The present invention is illustrated by way of example, and not necessarily by way of limitation in the figures of the accompanying drawings in which like reference numerals refer to similar elements.

FIG. 1 is a block diagram of a hybrid fiber/coax (HFC) cable TV architecture within which the teachings of the present invention can be practiced, in accordance with one embodiment of the present invention;

FIG. 2 is a graphical illustration of an example forward error correction frame format typically utilized in CATV-based broadband data networks;

FIG. 3 is a block diagram of an example cable modem incorporating an innovative synchronization agent that removes gaps from received MPEG data stream to facilitate synchronization with the CMTS, according to one example embodiment of the present invention;

FIG. 4 is a block diagram of an example control loop suitable for use within the synchronization agent to remove gaps from the received MPEG data stream;

FIG. 5 illustrates a circuit diagram of an example implementation of the control loop which effectively reduces the effect of gaps in a received data signal on the timebase generated therefrom, in accordance with the teachings of the present invention;

FIG. 6 is a flow chart of an example method for synchronizing a cable modem with a cable modem termination station, according to the teachings of the present invention;

FIG. 7 is a graphical illustration of a timing diagram showing the removal of gaps from a generalized input data stream, according to one example implementation of the present invention;

FIG. 8 illustrates an accumulator plot depicting the relationship between the phase accumulation and the resultant timbase generated by the numerically controlled oscillator of the present invention;

FIG. 9 graphically illustrates two frequency diagrams depicting the difference between a local timing reference in a conventional cable modem and the CMTS transmitted timing reference, and a cable modem incorporating the innovative synchronization agent and the CMTS reference; and

FIG. 10 illustrates a block diagram of an example storage medium comprising a plurality of executable instructions which, when implemented by an accessing computing system, implements the synchronization agent in accordance with the teachings of the present invention.

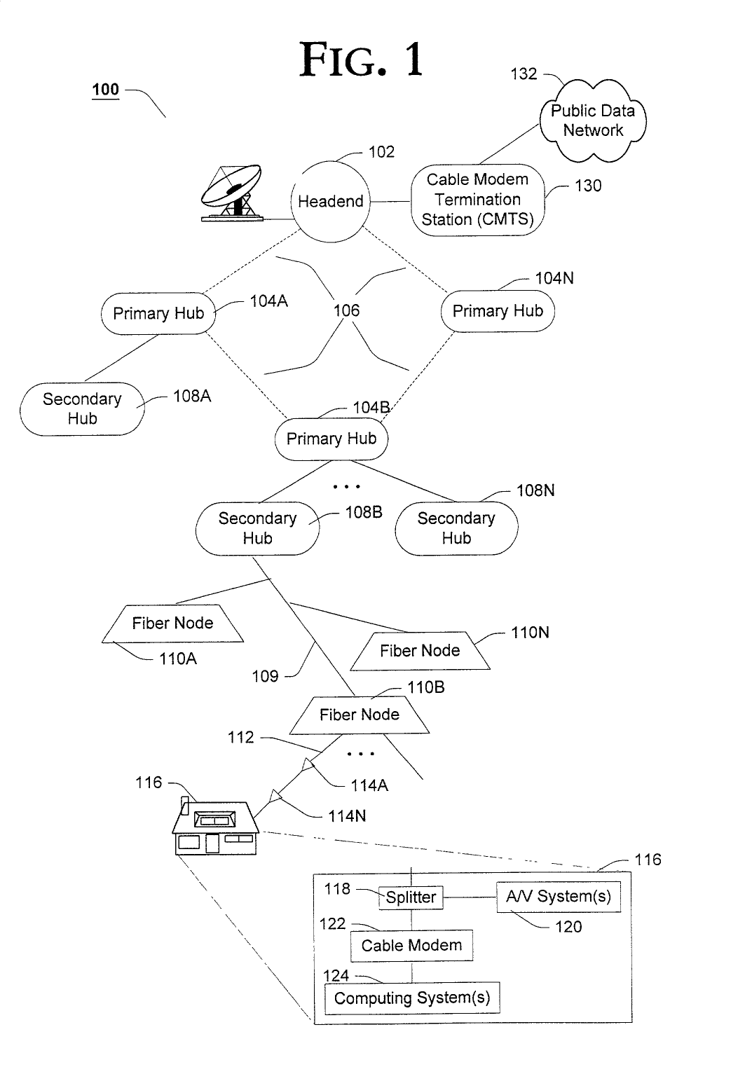

### DETAILED DESCRIPTION

This invention is generally drawn to a method and apparatus to enable a cable modem (CM) to accurately synchronize framing timing references with a cable modem termination station (CMTS). In this regard, an innovative synchronization agent is introduced which effectively removes the gaps from a received data stream containing timing synchronization information, thereby removing jitter created in a resultant timebase caused by the gaps in the received data stream. In accordance with one aspect of the present invention, the synchronization agent utilizes a first-in, first-out buffer (FIFO) to receive the information stream containing, at least in part, the timestamp information. A control loop within the synchronization agent utilizes a numerically controlled oscillator driven by the nominal difference in the number of writes and reads to/from the FIFO over a period of time to normalize processing of the timestamp information. More particularly, as will be developed more fully below, the synchronization agent couples a negative feedback control loop with a data rate conversion first-in, first-out (FIFO) buffer as the numerically controlled oscillator (NCO) which generates a smooth output data stream without overflow/underflow in the FIFO. The control loop utilizes the forward error correction (FEC) frame period of the incoming data stream as the measurement interval for equalizing the frequency of the stream. Accordingly, a method and apparatus facilitating synchronization in a timestamp based communication system, which uses error correction or any other framing/physical layer overhead in the channel, without explicitly locking on the symbol rate.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner in one or more embodiments.

Example Cable Modem Architecture

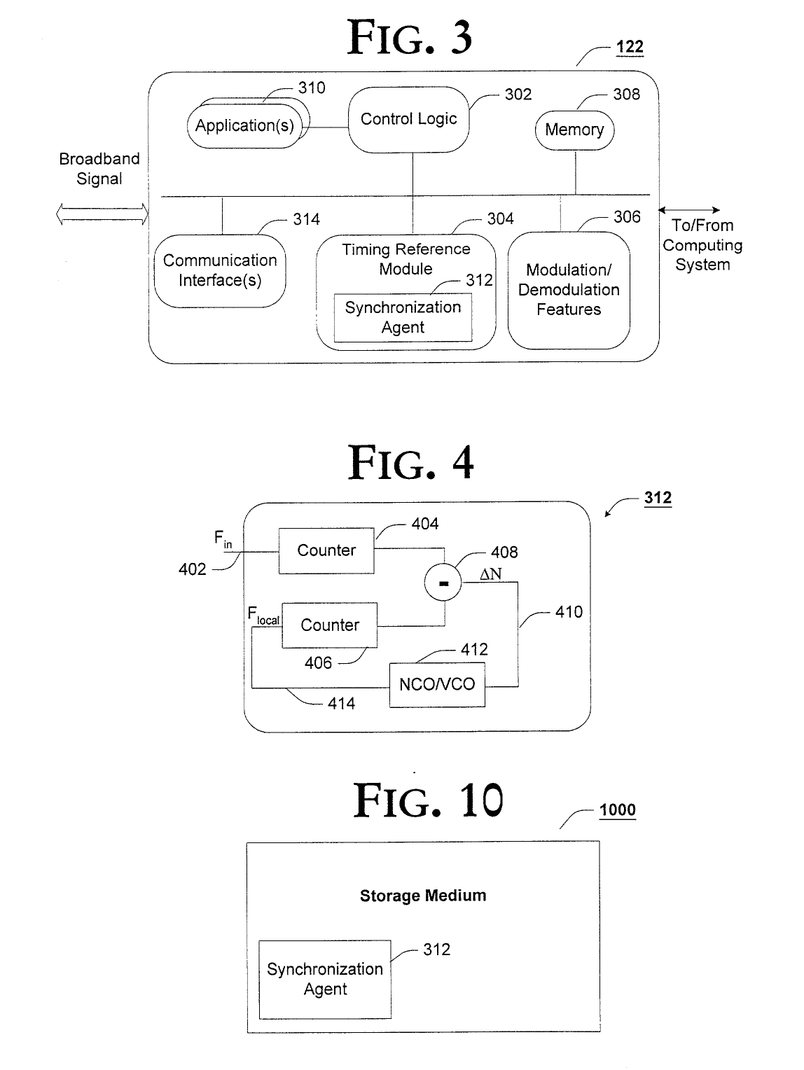

FIG. 3 is a block diagram of a simplified cable modem incorporating an innovative synchronization agent to remove gaps in a received timestamp based communication signal to accurately generate a local reference clock based on the received communication signal. In accordance with the illustrated example implementation, the cable modem 122 receives an MPEG compliant data stream that, as a result of the FEC to MPEG framing process described above, includes gaps which, left unchecked, would have a detrimental effect on the cable modem's ability to accurately synchronize with the CMTS (e.g., 130).

In accordance with the illustrated example implementation of FIG. 3, cable modem 122 is depicted comprising control logic 302, a timing reference module 304 including the innovative synchronization agent 312, modulation and demodulation features 306, memory 308, communication interface(s) 314 and, optionally, one or more applications 310. It should be appreciated that although depicted as a number of separate functional elements 302-314, one or more of such elements may well be integrated without deviating from the spirit and scope of the present invention

Control logic 302 controls the overall function of the cable modem 200. In this regard, control logic 302 selectively implements the modulation/demodulation features 306 to communicatively couple a computing system with a data network through a cable modem termination station (CMTS). In accordance with the illustrated example implementation, modem 122 includes applications 310 which are selectively invoked and implemented by control logic 302 to control certain operational aspects of cable modem 122. According to one example implementation of the present invention, to be described more thoroughly below, channel detection agent 312 is a series of executable instructions stored in accessible memory (e.g., 308) as an application 310, which is selectively invoked and executed by control logic 302. Except as configured to effect the teachings of the present invention, control logic 302 is intended to represent any of a number of alternate control systems known in the art including, but not limited to, a microprocessor, a programmable logic array (PLA), a micro-machine, an application specific integrated circuit (ASIC) and the like. In an alternate implementation, control logic 302 is intended to represent a series of executable instructions to implement the control logic described above.

Communication interface(s) 314 and memory 308 are each intended to represent any of a number of computing/network interface(s) and memory devices known in the art. In this regard, computing/network interface(s) are intended to represent any of a number of interface(s) used by modem 122 to interface with an HFC network, local area network (LAN) or wide area network (WAN) element(s), any of a number of computing devices including, but not limited to, a personal computer, a set-top box, a personal digital assistant, and the like. Accordingly, computing/network interface(s) 314 may well include one or more of a universal serial bus (USB) interface, a Personal Computing Interface (PCI) bus interface, an Ethernet interface, a wireless networking interface, an infrared interface, a serial bus interface, a parallel bus interface, a direct memory access (DMA) interface, an HFC network interface, and the like.

As used herein, memory 308 is used by control logic 302 to store and maintain a number of cable modem operating parameters such as, for example, look-up tables, data channel assignments, etc. In this regard, memory 302 is intended to represent one or more of volatile memory device(s), non-volatile memory device(s), mass storage device(s), optical storage device(s), and the like.

In accordance with the illustrated example implementation, cable modem 122 includes modulation/demodulation features 306. According to one example embodiment, modulation/demodulation features 306 are embodied within one or more modulators and demodulators which may or may not be integrated. Those skilled in the art will appreciate that control logic 302 utilizes modulation features 306 to format communication information in the format necessary to generate an upstream data communication channel component. In accordance with the illustrated example implementation, modulation features 306 includes a quadrature phase shift keying (QPSK)/quadrature amplitude modulation (QAM) modulator to format data received from a communicatively coupled computing system using Reed-Solomon encoding and QPSK or QAM-16 modulation for transmission in bursts to the CMTS. As introduced above, control logic 302 issues a request for bandwidth from the CMTS (130) before transmitting in the upstream.

Similarly, on the downlink side, control logic 302 utilizes demodulation features 306 to demodulate data received via the broadband communication channel into a format suitable for use by a communicatively coupled computing system. In accordance with the illustrated example implementation, demodulation features 306 include a M-ary QAM demodulator to demodulate a received 64- or 256-QAM broadband signal.

As introduced above, the ability of the cable modem 122 to function with the CMTS (130) requires that these network elements (i.e., the CMTS and the CM) are synchronized. As introduced above, while the CMTS provides timestamp information in the transmitted data stream to enable CM's to synchronize to the CMTS, processing artifacts and network transmission may well introduce gaps or “noise” into the received signal which inhibits the accurate and timely processing of the timestamp information. The variable nature of the data stream comprising the timestamp information may introduce untenable jitter into the local clocking source used to process the timestamp information, resulting in a lack of synchronization. To alleviate this problem, cable modem 122 is depicted comprising synchronization agent 312 in timing reference module 304. As will be developed more fully below, synchronization agent 312 receives the demodulated MPEG data stream and dynamically generates a local timebase using a numerically controlled oscillator (NCO) gated by a periodic measurement of the difference in writes and reads to/from a first-in, first-out (FIFO) buffer. It will be shown that this normalization of the reads/writes provides a steady local reference clock with which to process the timestamp information.

While introduced in the context of the illustrated cable modem implementation, it will be appreciated from the discussion to follow that the innovative synchronization agent 312 described herein will be readily adapted to any implementation which requires the generation of a data clock from a timestamp based communication signal. In this regard, the illustrated cable modem implementation is but one of a number of suitable applications for the synchronization agent.

Example Synchronization Agent Architecture

Turning to FIG. 4 a simplified block diagram of an example synchronization agent 312 is presented, in accordance with one example implementation of the present invention. More particularly, the block diagram of FIG. 4 illustrates an example control loop with negative feedback to reduce or eliminate any “jitter” caused by gaps in the received data stream introduced to the NCO. More particularly, FIG. 4 illustrates a control loop to frequency lock to an input clock. In accordance with the illustrated example implementation of FIG. 4, synchronization agent 312 is depicted comprising two counters 404 and 406, a summing module 408, and a numerically controlled oscillator/voltage controlled oscillator (NCO/VCO) 412, each coupled as depicted.

As used herein, Fᵢₙ 402, received at counter 404, represents the input data stream (e.g., MPEG data stream) received from, e.g., CMTS 130 and is assumed to contain gaps. F_{local} represents the desired equalized reference clock that is used to process the timestamp information. As shown, summing module 408 periodically calculates an error value, ΔN. This error value, ΔN, represents the difference between the clocking signal provided by the received input stream and the feedback (F_{local}) from the NCO 412. According to one example implementation, discussed more fully below, this error value ΔN is calculated every N rising edges of the input data stream (Fᵢₙ), wherein N is associated with the frame period of the received data stream.

The numerically controlled oscillator 412 receives this error value ΔN and generates an equalized clock signal F_{local} 414. In this regard, the feedback of control loop of FIG. 4 is used to generate an error value ΔN, which is used to effectively drive F_{local} 414 generated by the NCO 412 to an average frequency of the received input stream Fᵢₙ 402. As used herein, the difference equation for the control loop of FIG. 4 is represented, mathematically, as:

F_{local}=Fₙ₋₁+ΔF (1)

where,

$$Δ F = \frac{Δ N}{T} \qquad ( 2 )$$

In equation (2), above, T represents the clock period of the counters 404 and 406, respectively. Those skilled in the art may well recognize that this FIG. 4 illustrates a first-order astatic regulator. Since the system is astatic, its accuracy depends only on the resolution of the NCO 412.

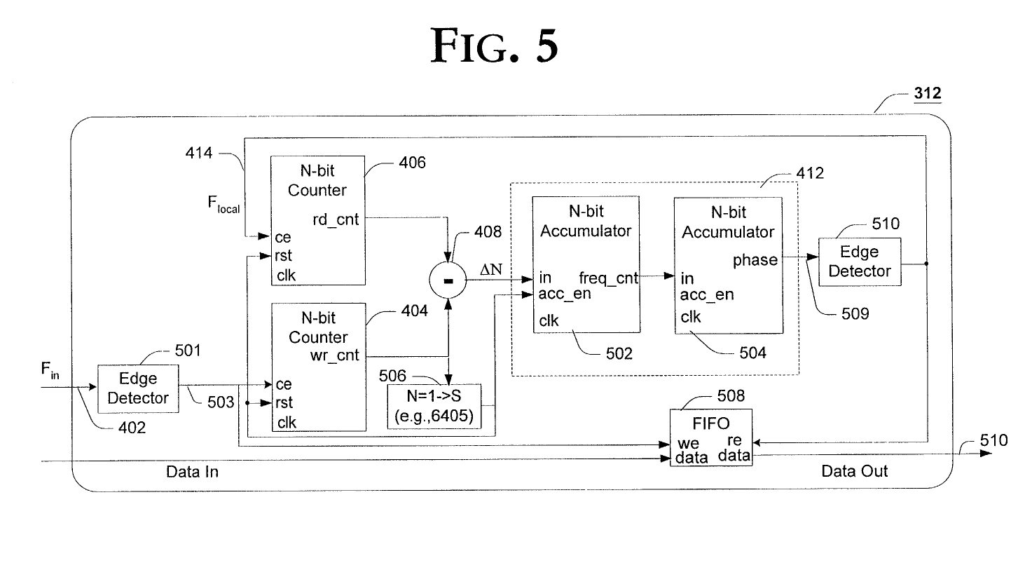

FIG. 5 illustrates a block diagram of an example architectural implementation of synchronization agent 312 depicting the control loop and numerically controlled oscillator in greater detail, according to one example embodiment of the present invention. In accordance with the illustrated example implementation of FIG. 5, synchronization agent 312 is depicted comprising the two counters 404 and 406, summing module 408 and NCO 412, each coupled as depicted. As shown, the NCO 412 of synchronization agent 312 is comprised of two, n-bit accumulators 502 and 504 which periodically accumulate frequency and phase representations of the error value ΔN. In addition, synchronization agent 312 is depicted comprising two edge detectors, 501 and 510, respectively, a programmable accumulator reference 506, and a first-in, first-out (FIFO) data buffer, each coupled as depicted.

As introduced above, counter 404 is coupled to Fᵢₙ 402 via edge detector 501, and maintains a count of the number of writes to the FIFO 508. That is, write counter 404 is incremented on every rising edge of the received Fᵢₙ 402. Counter 406 receives feedback from the NCO 412 through edge detector 510, which enables reads from the FIFO 508. In this regard, counter 406 maintains a count of the number of reads from FIFO 508, enabled by each rising edge detected by edge detector 510, and is thus referred to herein as read counter 406. In order to maintain balance in the FIFO, the number of reads from the FIFO should equal the number of writes to the FIFO over the period N (defined programmatically in accumulator reference 506).

As introduced above, summing module 408 generates a differential value between counters 404 and 406. As illustrated in FIG. 5, this differential represents the difference in the number of writes and reads to/from FIFO 508 over a period of time dictated, programmatically, by accumulator reference 506. In accordance with one example implementation, accumulator reference 506 is programmed to the period N of the received data stream, Fᵢₙ 402. According to one example implementation, N is associated with the number of clocks per gap period. In this regard, the relationship between the desired equalized period (Teq) (i.e., associated with F_{local}) and the gap period (Tgap) (i.e., associated with Fᵢₙ) may be represented mathematically as:

$$Teq = \frac{Tgap}{N} ⇒ N = \frac{Tgap}{Teq} \qquad ( 3 )$$

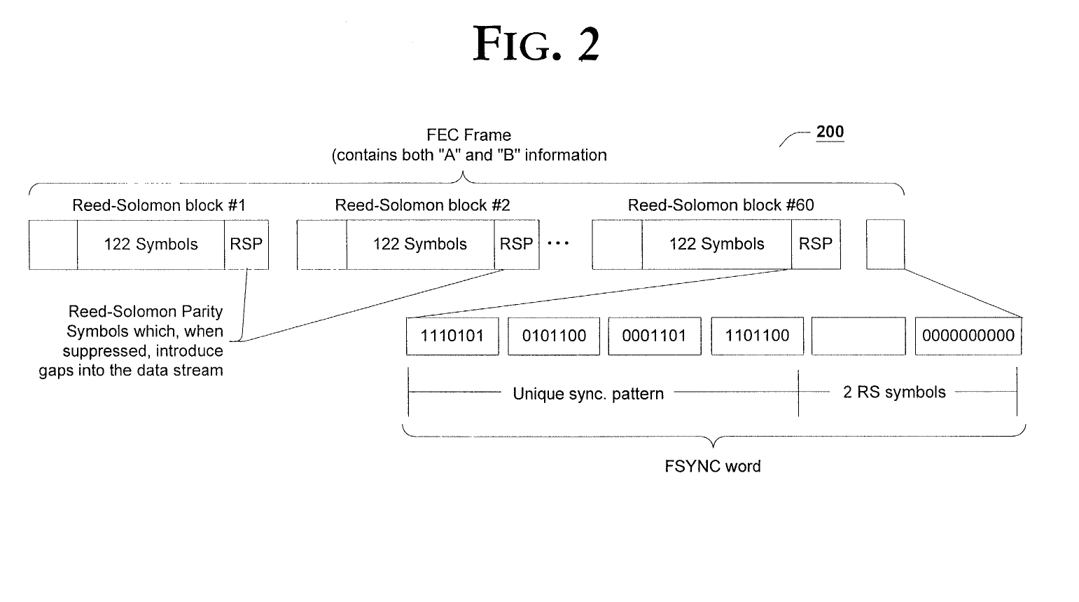

The equalized period (Teq) is the average period of the FEC clock over the FEC frame period. Accordingly, in the case of a 64-QAM, ITU-T J0.83 annex B compliant MPEG data stream introduced above with reference to FIG. 2, N resolves to 6405 clocks per gap period, as illustrated below:

$$N = \frac{Tgap}{Teq} = \frac{60 blocks \times 122 \frac{symbols}{block} \times 7 \frac{bits}{symbol}}{8 bits} = \frac{51240}{8} = 6405 \qquad ( 4 )$$

Thus, in accordance with one example implementation, accumulator reference 506 is programmed to enable NCO 412 to receive the error differential ΔN every 6405 rising edges of Fᵢₙ 402.

In accordance with the illustrated example implementation of FIG. 5, NCO 412 is depicted comprising two, n-bit accumulators 502 and 504, respectively. As shown, accumulator 502 is coupled to summing module 408 and accumulator reference module 506. As introduced above, the NCO 412 receives the error differential ΔN at accumulator 502 and periodically (dictated by accumulator reference 506) accumulates the ΔN value into freq_cnt. That is, every 6405 rising edges of Fin 402, accumulator reference 506 enables accumulator 502 to accumulate the ΔN output of summing module into freq_cnt.

The freq_cnt accumulator 502 is coupled to phase accumulator 504, wherein the accumulated frequency count information is provided to the phase accumulator. The most significant bit (MSB) of the value of the phase accumulator is used to synthesize the read clock. More particularly, once the MSB of the phase accumulator 504 reaches a threshold, the edge detector 510 is enabled generating F_{local}, which enables a read from the FIFO 508. The slope of the phase accumulator is directly proportional to the freq_cnt input value. This relationship determines the frequency of the synthesized read clock, F_{local} 414, according to the equation:

$${F}_{local} = freq\_cnt \times \frac{{F}_{sysclk}}{{2}^{N - 1}} \qquad ( 5 )$$

where,

$$\frac{{F}_{sysclk}}{{2}^{N - 1}}$$

is the frequency resolution of the NCO 412. Accordingly, by accumulating the error differential, ΔN, between the read and write counters in the freq_cnt accumulator 502, the differential drives the output of the NCO 412, F_{local} 414, to the average frequency of Fᵢₙ 402.

In accordance with the illustrated example of FIG. 5, synchronization agent 312 includes a first-in, first-out (FIFO) buffer 508 to receive the input data stream. As introduced above, reads from the buffer are enabled by NCO 412 according to the average frequency of the input data stream, Fᵢₙ 402. In this regard, those skilled in the art will appreciate that FIFO 508 is used to buffer data when gaps occur. Thus, the output of the synchronization agent 312 provides a “gapless” data stream 512 from an input data stream Fᵢₙ 402 replete with gaps.

It will be appreciated that, although depicted as comprising a number of seemingly disparate elements 402-512, may well be integrated into common elements. That is, although represented as two individual devices, each of the n-bit counters could well reside in a single integrated circuit (IC) package. Similarly, each of the accumulators, or each of the edge detectors may well reside in a common IC package, respectively. Thus, synchronization agents 312 with greater or lesser complexity which nonetheless improve the accuracy of a timestamp based clocking system by removing gaps from the received reference are anticipated within the scope and spirit of the present invention.

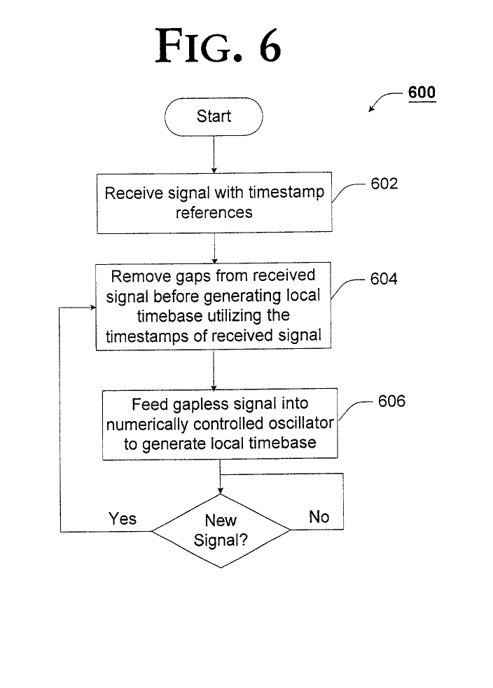

FIG. 6 is a flow chart of an example method for effectively removing gaps from a received input signal to facilitate timebase synchronization between two network elements, e.g., a CMTS 130 and a CM 122. As introduced above, in certain implementations, a received broadband signal including essential timestamp information may well include unwanted artifacts, e.g., gaps, which impair the ability of the receiving network element, e.g., the CM 122, to achieve an accurate timebase synchronization using the received signal. To alleviate this variability and improve timebase synchronization with the remote network element, e.g., CMTS, the impact of the signal processing artifacts must be eliminated or reduced to within a tolerable level—such is the task of the innovative synchronization agent 312, the operation of which will be further described with reference to the method of FIG. 6.

As shown, the method 600 begins with block 602 wherein modem 122 receives a broadband signal comprising timestamp information from a CMTS 130. In accordance with the teachings of the present invention, control logic 302 of modem 122 directs at least a subset of the received signal Fᵢₙ 402 to synchronization agent 312.

In block 604, synchronization agent generates an equalized reference clock, F_{local} 414, from the input data stream Fᵢₙ 402. In accordance with the teachings of the present invention, described more fully above, synchronization agent 312 generates the equalized reference clock using a numerically controlled oscillator (NCO) 412 which is driven by an differential error value, ΔN, representing the difference between writes and reads of the input data stream to a buffer 508. The NCO, comprised of two accumulators 502 and 504, further attenuates the impact of any gaps by generating a read enable signal based on the MSB of the accumulated error value ΔN.

In block 606, synchronization agent 312 utilizes the generated equalized reference clock F_{local} 414 to enable reads from the buffer to generate a normalized output of the non-normalized input data stream including the timestamp information. In this regard, synchronization agent 312 facilitates the equalized delivery of timestamp information received in a non-equalized fashion.

In block 608, synchronization agent 312 determines whether additional signal(s) are received and, if so, the process continues with block 604 as the equalized reference clock, F_{local} 414, resolves to the average frequency of the received input data signal, Fᵢₙ 402.

Graphical Illustration(s)

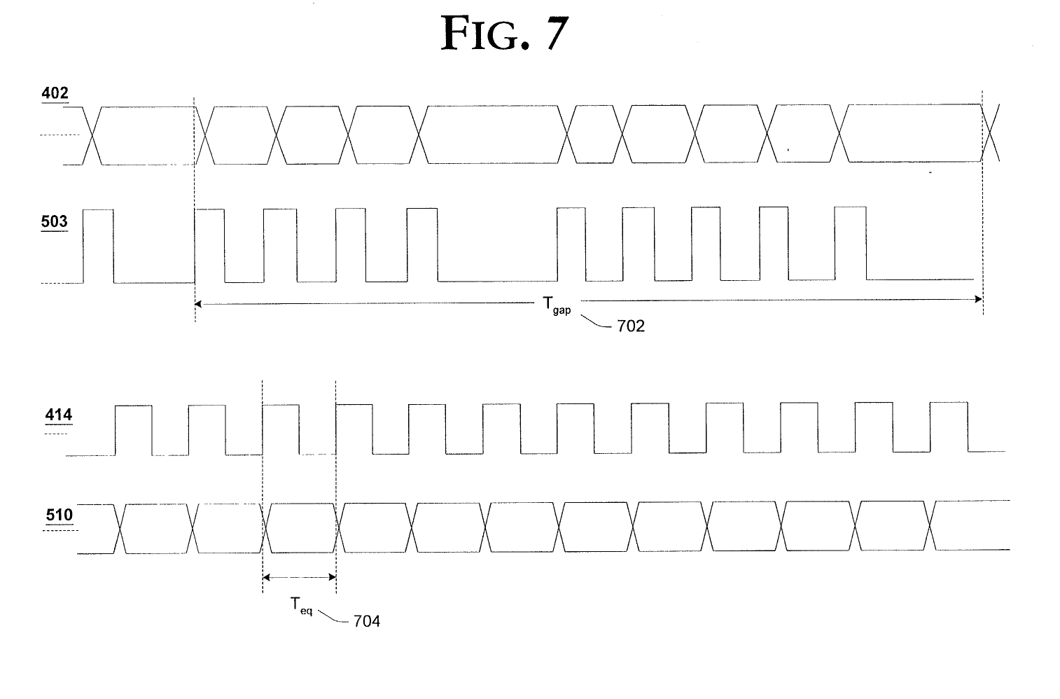

For ease of understanding, the equalization features of synchronization agent 312 introduced above are illustrated graphically with reference to FIGS. 7, 8 and 9, respectively.

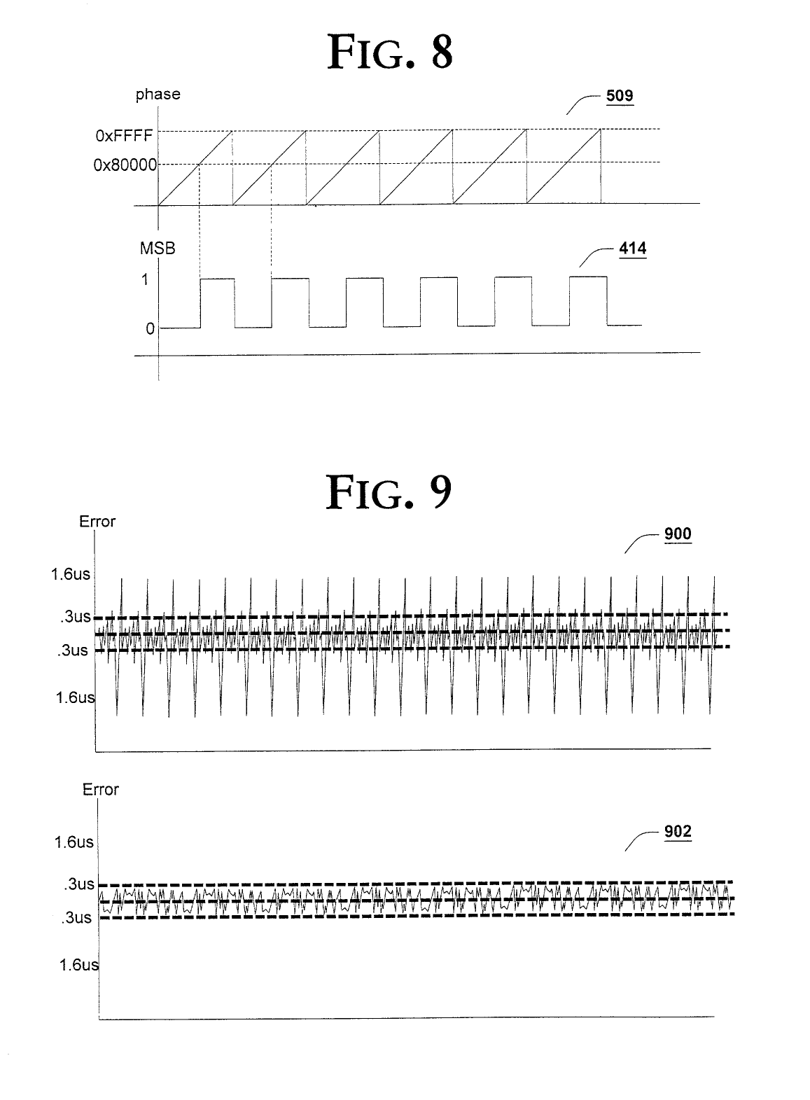

Turning to FIGS. 7-9, the operational result of certain elements of synchronization agent 312 is depicted graphically to illustrate the equalization features of synchronization agent 312. With initial reference to FIG. 7, a timing diagram illustrating the operational signal at certain points of the synchronization agent is depicted. In accordance with the illustrated example, signal 402 represents the input data stream, Fᵢₙ, replete with gaps introduced during the signal processing and transmission to the CM 122. Signal 503 illustrates the result of edge detector 501 processing of the input data stream 402, and provides an illustration of the reference clock that would be generated if simply utilizing the input data stream. As introduced above, simply utilizing the received input stream Fᵢₙ 402 to generate a local reference clock would introduce untenable jitter into the reference controlling processing of the timestamp information, i.e., exceeding the 0.5 us threshold of conventional NCO's. An example of a reference clock generated using the un-equalized input data stream (Fᵢₙ 402) is presented as signal 900 in FIG. 9.

With continued reference to FIG. 7, signal 414 illustrates the result of generating an equalized clock signal F_{local} 414, which resolves to roughly the average of Fᵢₙ 402. By equalizing the reference clock F_{local} 414 in this manner, the gaps from the input data stream 402 are removed, as evidenced by the output data stream 510 of FIG. 7. In addition to the foregoing, FIG. 7 graphically illustrates the respective relationship between Tgap 702 and Teq 704.

While depicting the relative inputs and outputs of the innovative synchronization agent, FIG. 7 does not depict the how the equalized frequency clock F_{local} 414 is achieved. That is, FIG. 7 fails to depict the processing performed within NCO 412. Accordingly, attention is directed to FIG. 8, which depicts how the equalized F_{local} 414 is generated.

Turning briefly to FIG. 8, a graphical representation of the generation of the local reference clock, F_{local} 414, is presented in accordance with one example implementation. As introduced above, NCO 412 is comprised of two accumulators, which periodically receive differential error value ΔN from summing module 408. This value, as it accumulates over a period of time generates a signal waveform 509 from accumulator 504. Once the MSB of the phase exceeds a threshold, edge detector 510 is enabled until the phase signal 509 drops below such threshold. Thus, the sawtooth waveform 509 generated by the NCO 412 is converted by edge detector 510 into F_{local} 414 depicted in FIGS. 7 and 8.

FIG. 9 graphically illustrates two timebase illustrations, one (900) generated using timestamp information from a received input stream in a conventional manner, and another (902) generated from timestamp information when the received input data stream has been stripped of gaps.

Alternate Embodiments

FIG. 10 is a block diagram of a storage medium having stored thereon a plurality of instructions including instructions to implement the synchronization agent 312, according to yet another embodiment of the present invention. In general, FIG. 10 illustrates a storage medium/device 1000 having stored thereon a plurality of machine-executable instructions including at least a subset of which that, when executed, implement the innovative synchronization agent 312 of the present invention.

As used herein, storage medium 1000 is intended to represent any of a number of storage devices and/or storage media known to those skilled in the art such as, for example, volatile memory devices, non-volatile memory devices, magnetic storage media, optical storage media, and the like. Similarly, the executable instructions are intended to reflect any of a number of software languages known in the art such as, for example, C++, Visual Basic, Hypertext Markup Language (HTML), Java, eXtensible Markup Language (XML), and the like. Moreover, it is to be appreciated that the storage medium/device 1000 need not be co-located with any host system. That is, storage medium/device 1000 may well reside within a remote server communicatively coupled to and accessible by an executing system. Accordingly, the software implementation of FIG. 10 is to be regarded as illustrative, as alternate storage media and software embodiments are anticipated within the spirit and scope of the present invention.

Although the invention has been described in the detailed description as well as in the Abstract in language specific to structural features and/or methodological steps, it is to be understood that the invention defined in the appended claims is not necessarily limited to the specific features or steps described. Rather, the specific features and steps are merely disclosed as exemplary forms of implementing the claimed invention. It will, however, be evident that various modifications and changes may be made thereto without departing from the broader spirit and scope of the present invention. The present specification and figures are accordingly to be regarded as illustrative rather than restrictive. The description and abstract are not intended to be exhaustive or to limit the present invention to the precise forms disclosed.

The terms used in the following claims should not be construed to limit the invention to the specific embodiments disclosed in the specification. Rather, the scope of the invention is to be determined entirely by the following claims, which are to be construed in accordance with the established doctrines of claim interpretation.

In accordance with the foregoing, we claim the following:

1. A method comprising:
receiving a data stream comprising timestamp information into a buffer, wherein the received data stream includes gaps; and
generating an equalized reference clock from the received data stream by removing the gaps to facilitate equalized processing of the timestamp information received in a non-equalized data stream.

2. A method according to claim 1, further comprising:
utilizing the equalized reference clock to enable equalized reads of the received data stream from the buffer.

3. A method according to claim 2, further comprising:
generating a local timebase from the timestamp information to synchronize the local timebase with a remote network element transmitting the received data stream.

4. A method according to claim 3, wherein the remote network element is a cable modem termination system (CMTS), and the received data stream is an Moving Picture Experts Group (MPEG) compliant data stream.

5. A method according to claim 1, wherein generating the equalized reference clock comprises:
generating an error value representing a difference in writes to and reads from the buffer; and
driving a numerically controlled oscillator (NCO) based, at least in part, on the generated error value.

6. A method according to claim 5, wherein the error value resolves to an average clock frequency of the non-equalized input data stream.

7. A method according to claim 5, wherein the output of the NCO enables reads from the buffer.

8. A method according to claim 5, wherein the output of the NCO is represented in the generated error value.

9. A method according to claim 8, wherein the output of the NCO is represented in the generated error value as enabling reads from the buffer.

10. A machine accessible storage medium comprising a plurality of executable instructions which, when executed by an accessing computing device, implements a synchronization agent to receive a data stream comprising timestamp information into a buffer, wherein the received data stream includes gaps, and to generate an equalized reference clock from the received data stream by removing the gaps to facilitate equalized processing of the timestamp information received in a non-equalized data stream from the buffer.

11. A machine accessible storage medium according to claim 10, further comprising instructions which, when executed, cause the accessing machine to utilize the generated reference clock to enable equalized reads of the received data stream from the buffer.

12. A machine accessible storage medium according to claim 11, further comprising instructions which, when executed, cause the accessing machine to generate a local timebase from the timestamp information to synchronize the local timebase with a remote network element transmitting the received data stream.

13. A machine accessible storage medium according to claim 10, wherein the instructions to generate an equalized reference clock include instructions to maintain a count of each of a number of writes to and reads from the buffer, and to generate a differential error value representing the difference in the number of reads and writes, wherein the differential error value is utilized to drive a numerically controlled oscillator (NCO) which generates the equalized reference clock.

14. A machine accessible storage medium according to claim 13, wherein the generated equalized reference clock resolves to approximately an average frequency of the received data stream.

15. An apparatus comprising:
a buffer to receive a data stream including timestamp information, the received data stream including gaps;
one or more counters, coupled to the buffer, to maintain a count of a number of respective writes to and reads from the buffer; and
a numerically controlled oscillator (NCO), coupled to the counters and the buffer, to periodically receive an indication representing a differential error value from the one or more counters and to generate an equalized reference clock which resolves to an average frequency of the input data stream.

16. An apparatus according to claim 15 further comprising:
a summing module, coupled between the one or more counters and the NCO, to receive a count reflective of the writes to and reads from the buffer and to generate a differential error value therefrom which is periodically sampled by the NCO, from which the equalized reference clock is generated.

17. An apparatus according to claim 15, wherein the NCO is comprised of:
one or more accumulators, to periodically accumulate the differential error value from the one or more counters and generate a signal representation therefrom.

18. An apparatus according to claim 17, further comprising:
an edge detector, coupled to the NCO, to receive the generated signal representation of the differential error value and, when the signal exceeds a threshold, generate a read enable.

19. An apparatus according to claim 18, wherein the read enable represents the equalized reference clock.

20. An apparatus according to claim 19, wherein the differential error value reflects feedback from the NCO as the number of reads from the buffer.
